(19) United States
(12) Patent Application Publication
(10) Pub. No.: US 2008/0028667 A1
(43) Pub. Date: Feb. 7, 2008

(54) Condition controllable bait receptacle and method

(76) Inventor: Andrew R. Grzybowski, West Dundee, IL (US)

Correspondence Address: Meroni & Meroni, P.C., P.O. Box 309, Barrington, IL, 60011, US

(21) Appl. No.: 11/499,367

(22) Filed: Aug. 4, 2006

(51) Int. Cl. A01K 97/05

(52) U.S. Cl. 43/57

(57) ABSTRACT

A bait receptacle assembly controls certain conditions of a bait-sustaining water quantity, such as the air condition and/or the heat condition thereof. The bait receptacle assembly comprises a bait receptacle, a select heat-transferring environment, a water quantity, and an aeration assembly. The bait receptacle receives the water quantity and live bait. The aeration assembly comprises a thermally conductive conduit portion directed through the heat-transferring environment and terminating in the water quantity for aerating the same. Airflow, having been heat-conditioned as it passes through the conduit portion, aerates the water quantity and enables heat energy transfer intermediate the heat-conditioned aeration and the water quantity for controlling the air and/or heat condition of the water quantity and thereby enables the user to help sustain the life of live bait received therein.

### BACKGROUND OF THE INVENTION

1. Field of the Invention

The present invention generally relates to a live bait receptacle and means for maintaining a viable bait-supporting environment therein. More particularly, the present invention relates to a bait receptacle having aeration means, which means function to allow the bait master to transfer heat into and out of the bait environment for maintaining a viable bait-supporting environment.

2. Description of the Prior Art

When a physical body (object, fluid, gaseous medium, etc.) is at a different temperature than its surroundings or another body, transfer of thermal energy, also known as heat transfer, occurs in such a way that the body and the surroundings reach thermal equilibrium. Thus, heat transfer always occurs from a hot material to a cold one, due to the second law of thermodynamics. Turning to a fishing scenario as a backdrop, it is further noted that fish can only survive with a sufficient oxygen supply and a habitat within certain temperature ranges. As water temperature increases, the water holds less oxygen. In relatively warmer water, the metabolism of cold-blooded animals, such as shrimp and fish, tends to speed up, increasing oxygen consumption and toxic waste production. It behooves the fishing enthusiast therefore, to keep the water in a bait well or bait receptacle relatively cool—preferably around 70° Fahrenheit or 21.1° Celsius. At this temperature bait will not only use less oxygen, but the water will more easily absorb oxygen when aerated. Bearing these notions in mind, and with a view to the prior art, it will be seen that a number of attempts have been made to develop apparatuses or devices to aid the fishing enthusiast prolong the life of bait fish and the like. Some of the more pertinent prior art relating to bait wells and the like is described hereinafter.

U.S. Pat. No. 3,654,773 ('773 patent), which issued to White, discloses a Controlled Temperature Bait Bucket. The '773 patent teaches a controlled temperature bait bucket comprising a small inner container with an insulated bottom and heat conducting sides within a large outer insulated bucket. The bucket is divided into two compartments by the container. The bait which is to be maintained at a controlled temperature is placed within the container, and the two compartments of the bucket are filled with a cooling agent. Fixed heat transfer means between the upper compartment and the container achieve initial cooling to optimum bait survival temperature and a manually controlled variable heat transfer means provides variable rate of heat transfer between the lower compartment and the container to maintain this temperature.

U.S. Pat. No. 3,800,462 ('462 patent), which issued to Coyle, discloses a Live-Well Aerator. The '462 patent teaches a submersible, battery operated, bilge pump located within a live-well in a boat serves to pump live well water through a hose to a section of rigid tubing having small holes along its length above the water surface to spray water back into the well at a 45 degree angle, for aeration and cooling. A length of plastic tubing from the rigid tube enables overboard discharge of a portion of pumped water as determined by a valve setting, to keep fresh water coming into the well through an underwater entrance port.

U.S. Pat. No. 3,815,277 ('277 patent), which issued to Murray, discloses an Aerated Bait Container. The '277 patent teaches a container or bait bucket or pail having a pump mounted therein with a suction inlet at a substantial elevation, but below water level, and with a discharge line extending first upwardly and then over to provide downwardly directed discharge ports spaced above water level to discharge water downwardly through air space for aeration. Thence, the discharge line turns downwardly to discharge further water through ports just above the bottom of the bucket, thereby to direct flow stream water to circulate and keep stirred up the bait, as shrimps, which might otherwise stack up at the bottom of the bucket and smother each other.

U.S. Pat. No. 3,831,310 ('310 patent) which issued to Frangullie, discloses a Live Bait Bucket. The '310 patent teaches a bucket to keep live bait from clustering together and thus shortening their lives, the bait bucket being divided into a number of bait storage compartments by means of spacers or partitions. The spacers preferably are perforated with a number of fluid-flow passages which are large enough to permit the flow of water, but are too small to permit the bait itself from passing between compartments. In addition, the bucket preferably includes a thermal compartment to provide some control over the temperature of the water in which the live bait is carried, a compartment that may be filled with ice in hot weather when the ambient temperature is low. An optional feature is an air stone or aerator in the bottom of the bait compartments, together with appropriate air tubing or passageways adapted for connection to a source of air.

U.S. Pat. No. 4,615,137 ('137 patent), which issued to Radmanovich, discloses an Energy Efficient Aerated Bait Container. The '137 patent describes a portable, insulated bait container for maintaining a variety of live bait types in a plurality of bait compartments. The container includes a pivotal carrying handle and a close fitting top for mounting over each of the provided compartments. At least one of the compartments being water filled and adjacent to which a life support compartment containing a battery operated aerator is included along with circuitry for automatically at selected times aerating the contained water. Alternatively, switch means permit manual operation.

U.S. Pat. No. 4,945,672 ('672 patent), which issued Raia, discloses a Water Circulating and Aerating Device for Live Bait Containers. The '672 patent teaches a water circulation and aerating device for live bait containers comprising a housing removably installed in existing bait containers which has apertures in the lower portion to prevent live bait from passing therethrough while allowing passage of water into the housing when the water level within the bait container rises. An intake conduit extends through the upper portion of the housing and has one end extending into the water in the bait container and a hose at the other end extending remote from the housing and a distance beneath the surface of the body of water being fished. An exterior pump at the remote end of the intake hose pumps cool water from beneath the surface of the body of water into the bait container. A venturi tube on the intake conduit mixes air into the water being pumped into the bait container. An interior pump within the housing becomes operative upon the water entering the housing reaching a predetermined level to pump the water back into the body of water being fished. Thus, the water introduced into the bait container is the same temperature as the body of water being fished and is aerated with fresh air and the warmer water discharged from the bait container will also contain metabolic wastes and nitrates created by the concentrated population.

U.S. Pat. No. 4,970,982 ('982 patent), which issued to Martin, discloses a Combination Livewell and Bait Well for Fishing Boats. The '982 patent teaches a fishing boat, a built-in tank which serves the combined function of a livewell for holding fish that are caught, and a bait well for receiving a minnow bucket. An electric pump powered by the battery of the boat pumps water from the lake into the tank in a manner to aerate the water and circulate it in the tank. A drain tube drains off water from the tank and prevents overflow. One half of the tank serves as a bait well in which a minnow bucket may be suspended. The other half of the tank is a livewell which receives newly caught fish. The livewell and bait well have separate hinged lids.

U.S. Pat. No. 5,050,335 ('335 patent), which issued to Hisey, discloses a Minnow and Fish Preserving Container. The '335 patent teaches a combination minnow and fish preserving container having a first section for containing water and minnows and a second section for containing water and a refrigerant, such as ice, and caught fish. The sections are separated by a thin wall cold conducting partition. The container is formed of insulated structural foam and has a substantially airtight lid portion defining when inverted molds for freezing suitably shaped blocks of ice. The container in use will maintain water and minnows at a temperature below 40 degrees F. whereby minnows in the first section are subjected to a substantial slowing of metabolism and are able to survive for a period of two weeks due to the insulating efficiency arrangement of the cold conducting partition and the substantially airtight closure. When transported to a fishing location, the catch is positioned in the second section where they are suitably refrigerated to maintain freshness for a desirable length of time.

U.S. Pat. No. 5,172,511 ('511 patent), which issued to Smith et al., discloses a Fish or Bait Preservation Apparatus and Method. The '511 patent teaches a fish or fish bait preservation apparatus and method utilizing ice as a coolant and piping bait or fish containing water therethrough to maintain this water at an automatic electronically controlled temperature and returning this water appropriately cooled to a fish or bait tank through a conductor having an aerating nozzle.

U.S. Pat. No. 5,231,789 ('789 patent), which issued to Radmanovich, discloses an Aerated Bait Container. The '789 patent describes a combination dry bait container and aerator apparatus adaptable to an inside wall of a commercially available, off-the-shelf, thermally insulated chest-type coolers. The apparatus includes a plastic molded insert having several small compartments formed therein, wherein each compartment opens only to the top thereof. The apparatus is adapted to be received into the reservoir of the insulated cooler and is selectively attachable to one of the side walls thereof. A battery-powered aeration pump is disposed in one of the small compartments defined in the insert and is coupled in air flow communication with the reservoir of the cooler containing water and live bait, such as minnows and leeches. The aeration pump supplies air to the water and thereby aerates the water to ensure the longevity of the live bait. The present invention also shields the live bait from extreme environments such as direct sunlight, or extreme and sub-zero temperature conditions. It is easily manufactured and requires relatively small tooling costs. It is also portable and can be adapted to any number of differently sized specified insulated coolers. Other small compartments defined in the insert can be used to store dry bait, such as worms or frozen smelt, but can also be used to store food or beverages.

U.S. Pat. No. 5,996,977 ('977 patent), which issued to Burgess, discloses a Temperature Adjusted Water Aerator and Circulation System. The '977 patent teaches an invention for an aquatic environment an aerator having a temperature adjusted air inlet for aerating a quantity of water in a container, where the temperature of air pumped through an aerator may be cooled or heated, the temperature adjusted air entrained with water, and exhausted through an outlet into a bait well or a larger container, such as a pond for raising aquatic livestock. The temperature adjusted air may be supplied from an air conditioning unit in an automobile, a portable or fixed refrigeration unit, or gas flowing through a chilled environment of cooled liquid. In another embodiment, the temperature adjusted air may be drawn through an underground or underwater thermal stabilized conduit, using the natural temperature stability of underlying formations or layers. In another embodiment, where warm air is preferred, alternative sources of temperature adjusted air may be used, as for instance, an automobile heater, heaters using combustible fuels or electrical resistance heating, and even the underground or underwater thermal stabilization conduit that is also used for cooling during summer months. In some embodiments, the aerator may float, may be positioned at some relatively fixed point in the container, such as on the bottom, or may be a variable buoyancy aerator that varies the level at which the aerator is situated in the container. In another embodiment, multiple aerators are controlled in a larger container for aerating and mixing the container, where the aerators draw temperature adjusted air from a manifold.

U.S. Pat. No. 6,962,019 ('019 patent), which issued to McDougle, discloses an Enhanced Filtration and Water Conditioning System for a Bait Tank. The '019 patent teaches a filtration and water conditioning system for a novel bait tank suitable for use in recreational boats, dockside and land based personal and commercial applications wherein water from the tank may be climactically controlled, filtered, purged of sediment, displaced scales and other fish waste and returned to the live well tank. Separate first and second water compartments within the tank function in concert with a second interior wall and a second interior bottom, a dual compartment filtration unit removably accommodated within the interior portion of the second compartment, and filtration unit inflow and outflow water conduits with each of the conduits communicably attaching the filtration unit to the first and said second interior water compartments. An independent circulatory means allows for water to be additionally withdrawn from the tank and introduced to a refrigerant based heat exchanger means, regulated in a manner to sustain a water temperature necessary to sustain the life of fish placed within the tank and then re-introduced into the tank.

United States Patent Application Publication No. US 2006/0016119, authored by Ashburn, Jr. et al., describes an article for maintaining the temperature of water housed in a bait tank. The article includes a first sheet or panel made of an insulating material configured for circumferentially enclosing the sides of the tank. Preferably, the panel is multi-layer and defines at least one opening for aligning with a port of the bait tank. Also preferably, the article includes a lid portion for insulating the top of the bait tank. Optionally, the panel can include at least one fishing rod holder for holding a fishing rod therein and at least one pocket for holding a cooling device such as a freezer pack.

From a review of these publications and other prior art generally known in the relevant art, it will be seen that the prior art does not teach a bait receptacle assembly comprising means to simultaneously aerate and heat-condition a bait-sustaining water quantity by pre-conditioning the aerating air flow by extracting or adding heat energy thereto and then aerating the water quantity with the heat-conditioned air flow. The prior art thus perceives a need for a bait receptacle assembly of the type heretofore briefly described as a means to further the state of the art in live bait retaining containers and the like.

### SUMMARY OF THE INVENTION

Accordingly, it is an object of the present invention to provide a bait receptacle assembly for enabling users thereof to control certain conditions of a bait-sustaining water quantity, such as the air condition and/or the heat condition. The bait receptacle assembly of the present invention essentially comprises a bait receptacle, a select heat-transferring environment, a water quantity, and an aeration assembly. The bait receptacle comprises a receptacle bottom and a receptacle wall. The heat-transferring environment comprises a first heat content for either imparting or drawing heat energy from matter passing therethrough. The water quantity is contained by the receptacle wall in superior adjacency to the receptacle bottom and comprises a second heat content, the first heat content of the heat-transferring environment being unequal to the second heat content of the water quantity.

The aeration assembly comprises certain aeration means and a thermally conductive conduit portion. The aeration means are cooperatively associated with the water quantity for enabling aeration thereof, and the conduit portion extends through the heat-transferring environment. The heat-transferring environment condition the air flow by exchanging heat energy therewith. The heat-conditioned air flow thereby develops a third heat content unequal to the second heat content. The conditioned air flow exits the aeration means thereby forming an aerated air flow. The third heat content of the aerated airflow enables heat transfer intermediate the water quantity and the aerated air flow for air-heat conditioning the water quantity. The air-heat conditioned water quantity may thus effectively function to sustain live bait.

The bait receptacle assembly may further comprise certain temperature-monitoring means such as any number of thermometers. The temperature-monitoring means enable the user to monitor the temperature of the water quantity. Together, the temperature-monitoring means and the aeration means enable the user to selectively control the air-heat condition of the water condition. The bait receptacle assembly may further comprise a handled outer container for retaining the bait receptacle, the heat-transferring environment, and the aeration means, and thus may further function to contain the bait receptacle assembly as a single unit and enable easy transport thereof.

The aeration assembly of the bait receptacle assembly may further comprise certain means for diverting the air flow or air-flow diversion means. The air flow diversion means essentially function to enable the user to selectively bypass the heat-transferring environment for delivering selectively conditioned air flow to the water quantity, the selectively conditioned air flow having a fourth heat content unequal to the first and second heat content(s) enabling heat transfer intermediate the selectively conditioned air flow and the water quantity for further controlling the air-heat condition of the water quantity. It is contemplated that the heat-transferring environment may be selected from the group consisting of an ice bath, a heater, and an ambient air quantity.

The present invention further contemplates certain methodology for controlling a bait-sustaining water temperature. In this regard, it is believed that the present invention discloses a water conditioning method comprising the step of monitoring the temperature of a bait-sustaining water quantity, the bait-sustaining water quantity temperature being subject to an acceptable temperature range as preferably chosen by the bait user or fishing enthusiast. The method further comprises the step of treating or conditioning the water quantity should the temperature exceed the acceptable range, as decided by the user. The process of water quantity treatment comprises the steps of directing air through a select heat-transferring environment and aerating the water quantity with the heat-conditioned airflow. In this regard, the heat-transferring environment transfers a first heat content into the air thereby forming the heat-conditioned air flow. Further, the water quantity, having a second heat content unequal to the first heat content, undergoes a temperature change as heat transfers intermediate the heat-conditioned airflow and the water quantity for returning the temperature to the acceptable range.

Other objects of the present invention, as well as particular features, elements, and advantages thereof, will be elucidated or become apparent from, the following description and the accompanying drawing figures.

### BRIEF DESCRIPTION OF THE DRAWINGS

Other features of our invention will become more evident from a consideration of the following brief description of patent drawings:

FIG. 1 is a fragmentary side view depiction of the bait receptacle assembly of the present invention with certain parts broken away to show otherwise hidden structure and a first preferred ice bath level.

FIG. 2 is a fragmentary side view depiction of the bait receptacle assembly of the present invention with certain parts broken away to show otherwise hidden structure and a second preferred ice bath level substantially similar to the first preferred ice bath level.

FIG. 3 is a fragmentary side view depiction of the bait receptacle assembly of the present invention with certain parts broken away to show otherwise hidden structure and a first alternative ice bath level.

FIG. 4 is a fragmentary diagrammatic depiction of an air flow delivery assembly including means for diverting air flow and three heat-transferring environments, including a heated environment, a chilled environment, and an ambient air temperature environment.

FIG. 5 is a fragmentary side view depiction of an air stone aerating or diffusing a heat-conditioned air flow into a water quantity depicting heat energy being transferred to the air flow from the water quantity.

FIG. 6 is a fragmentary side view depiction of an air stone aerating or diffusing a heat-conditioned air flow into a water quantity depicting heat energy being transferred from the air flow to the water quantity.

### DETAILED DESCRIPTION OF THE PREFERRED EMBODIMENT(S)

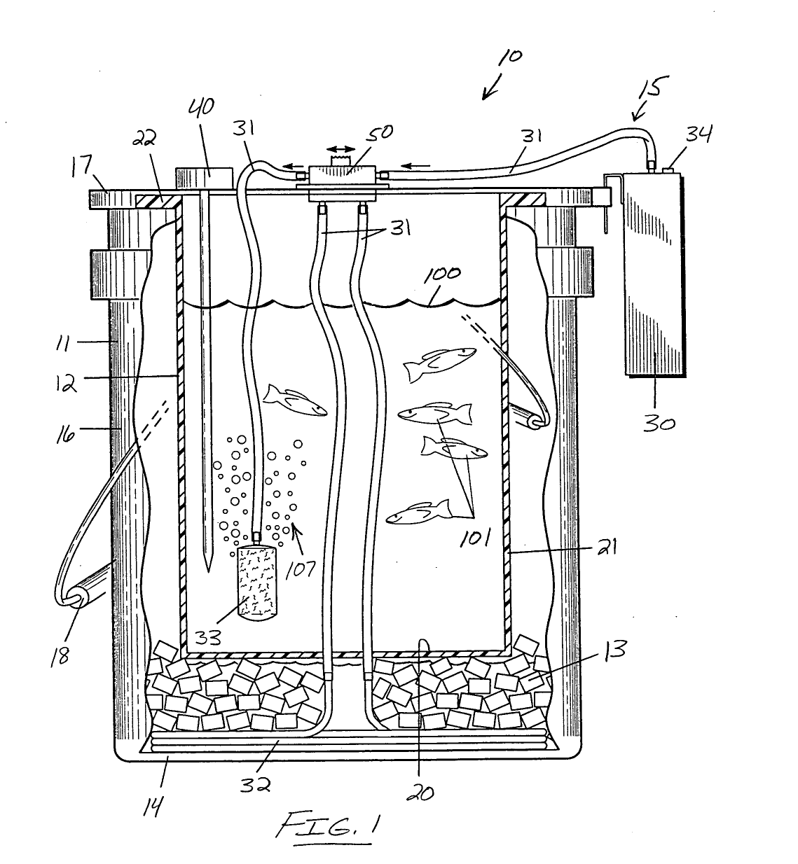

Referring now to the drawings, the preferred embodiment of the present invention generally concerns a bait receptacle assembly 10 as illustrated and referenced in FIGS. 1-3. It is contemplated that the bait receptacle assembly of the present invention functions to enable a user thereof to control certain conditions of a water quantity 100 in order to sustain live bait 101 such as minnows and the like as further referenced in depicted in FIGS. 1-3. The bait receptacle assembly 10 of the present invention thus preferably comprises, in combination an outer container 11 as illustrate and referenced in FIGS. 1-3; an inner bait receptacle 12 as illustrated and referenced in FIGS. 1-3, 5, and 6; an outer ice bath 13 as illustrated and referenced in FIGS. 1-4; an inner water quantity 100 as illustrated and referenced in FIGS. 1-3, 5, and 6; and an air delivery assembly 15 as generally illustrated and referenced in FIGS. 1-3.

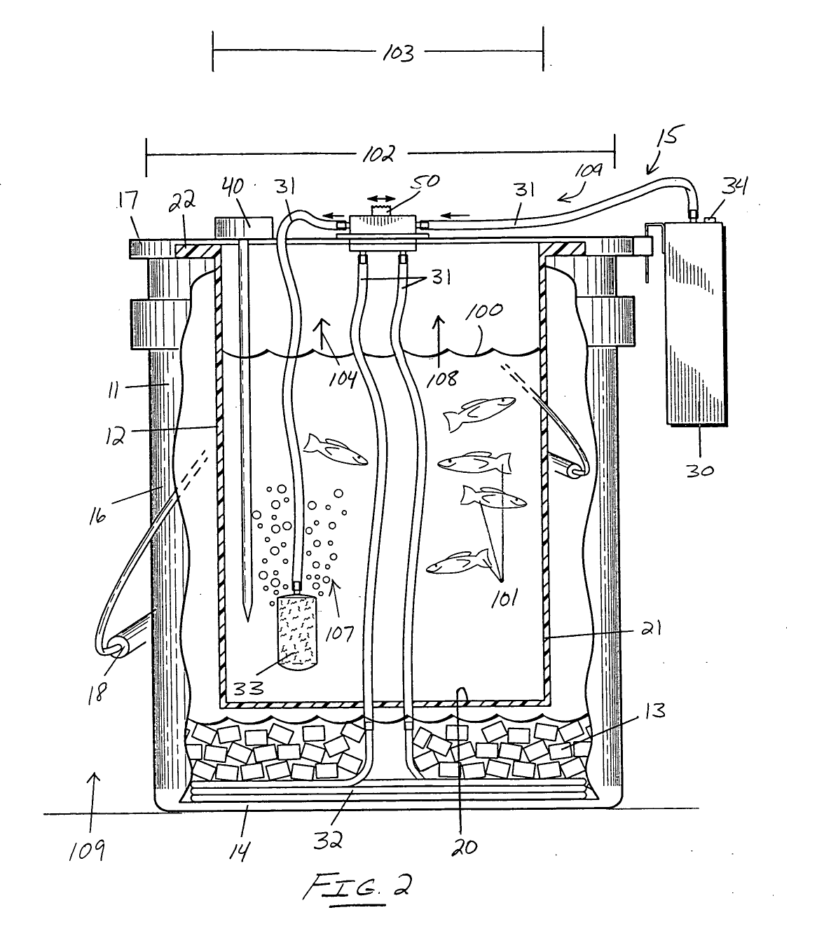

The outer container 11 may be preferably be constructed from a handled bucket comprising thermally insulative material(s) having a circular transverse cross-section of a first diameter 102 as may be found in a 3.5 gallon bucket as generally depicted and referenced in FIG. 2. The outer container 11 preferably comprises a container bottom 14, a container wall 16, and a container top 17 as illustrated and referenced in FIGS. 1-3. Certain means for enabling the user to more easily and manually (in other words, with one's hand) carry or transport the laden outer container 11 or bait receptacle assembly 10 are contemplated. In this regard, a handle 18 may define the means for manually transporting the bait receptacle assembly as generically depicted in FIGS. 1-3.

The inner bait receptacle 12 may be preferably constructed from a bucket type structure comprising thermally insulative material(s) also having a circular transverse cross-section, the diameter 103 of which is lesser in magnitude than the first diameter 102 as may be found with a 2 gallon bucket as comparatively depicted and referenced in FIG. 2. It will be understood from an inspection of noted figure(s) that the bait receptacle 12 is received by the outer container 11, preferably in coaxial relation, and comprises a receptacle bottom 20 as illustrated and referenced in FIGS. 1-3, 5, and 6; a receptacle wall 21 as illustrated and referenced in FIGS. 1-3, 5, and 6; and a receptacle top 22 as further illustrated and referenced in FIGS. 1-3.

The outer ice bath 13 essentially functions to transfer or draw heat energy 104 from objects, structures, or matter passing therethrough having unequal and higher heat content thereby lowering the heat content of the through passing matter. It will be seen from an inspection of the noted figures that the ice bath 13 is preferably received and contained by the container wall 16 in superior adjacency to the container bottom 14 and may be said to comprise a certain first heat content, the temperature thereof being relatively near or adjacent the freezing point of water or 0° Celsius.

The inner water quantity 100 essentially functions to sustain live bait 101 such as minnows or similar other water-viable bait. It will be seen from an inspection of the noted figures that the water quantity 100 is preferably received and contained by the receptacle wall 21 in superior adjacency to the receptacle bottom 20 and may be said to comprise a certain second heat content, which second heat content is preferably (and typically) unequal and higher than the first heat content of the ice bath 13.

It is noted that live bait 101 such as minnows and the like can only survive with a sufficient oxygen supply and a habitat within certain temperature ranges. As water temperature increases, the water holds less oxygen. In warm water, the metabolism of cold-blooded animals, such as fish, tends to speed up, increasing oxygen consumption and toxic waste production. It is therefore often necessary to keep the water relatively cool—preferably around 21.1° Celsius, during hot summertime ambient temperatures. At this temperature bait will not only use less oxygen, but the water will more easily absorb oxygen when aerated. It is further noted that live bait caught or purchased should be gradually acclimated to the water temperature in the bait container or receptacle. An abrupt change will shock the bait. Bait can tolerate a change of several degrees Celsius per half hour until the holding temperature, usually about 21.2° Celsius, is reached. Water temperatures straying too far from this parameter tend to threaten the life of the bait or result in sluggishly active bait. In any event, the water temperature of inner water quantity 100 should be well above 0° Celsius and thus the second heat content is preferably higher than the first heat content as heretofore presented.

The air delivery assembly 15 preferably comprises a state of the art air pump 30, a generic housing for which has been illustrated and referenced in FIGS. 1-3. Further, the air delivery assembly comprises a conduit assembly, including flexible hose type conduit 31 as illustrated and referenced in FIGS. 1-3, 5, and 6; and a thermally conductive (aluminum or copper) coil type conduit 32, which portion is ice-bathable as generally illustrated and referenced in FIGS. 1-3. Still further, it is contemplated that the air delivery assembly 15 preferably comprise certain aeration or air-diffusing means, as may be defined by a diffuser or air stone 33 as illustrated and referenced in FIGS. 1-3, 5, and 6. Notably, aeration is the process of dissolving air in a liquid (usually water). Usually aeration is achieved by passing air through the liquid. A diffuser or air stone is often utilized to produce small bubbles of air which increases the rate of aeration due to the higher contact surface area; this notion being central to the present invention.

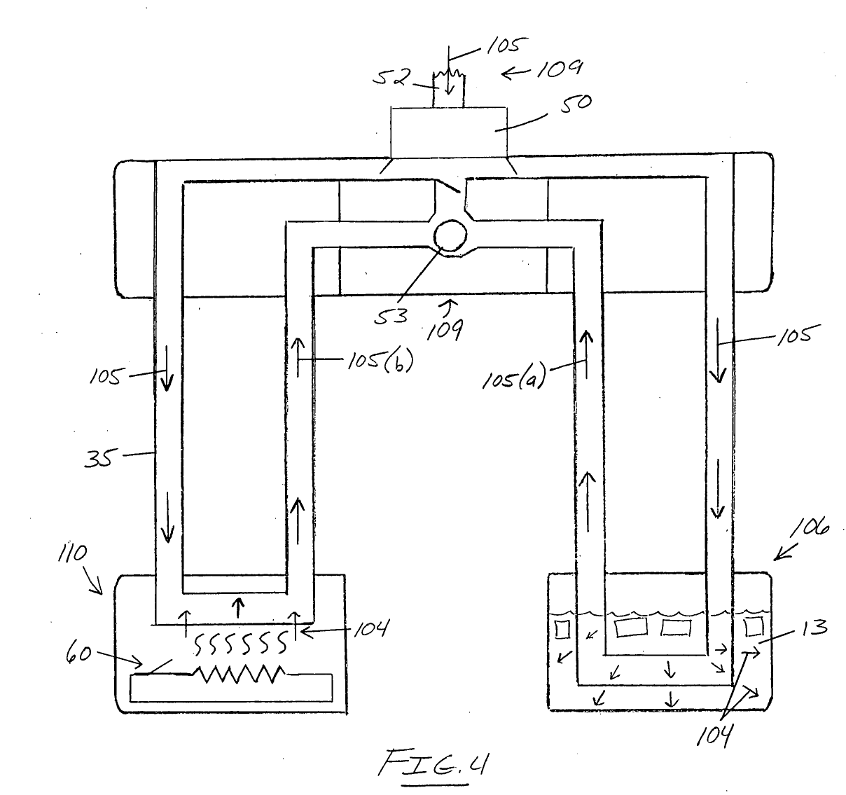

The conduit assembly communicates the air pump 30 with the aeration means for enabling air flow 105 therebetween, which air flow 105 initially has a third heat content, substantially equal in magnitude to the ambient air temperature surrounding the bait receptacle assembly 10. The ice-bathable portion of the conduit assembly or conduit 32 is preferably submerged in the ice bath 13 in inferior adjacency to the receptacle bottom 20 and functions to absorb heat energy 104 from the air flow 105 as diagrammatically depicted in FIG. 4 at reference numeral 106. The ice-bathed air flow 105(a) thereby comprises a fourth heat content greater than or substantially equal to the first heat content of the ice bath 13, but less than the second heat content of the water quantity 100.

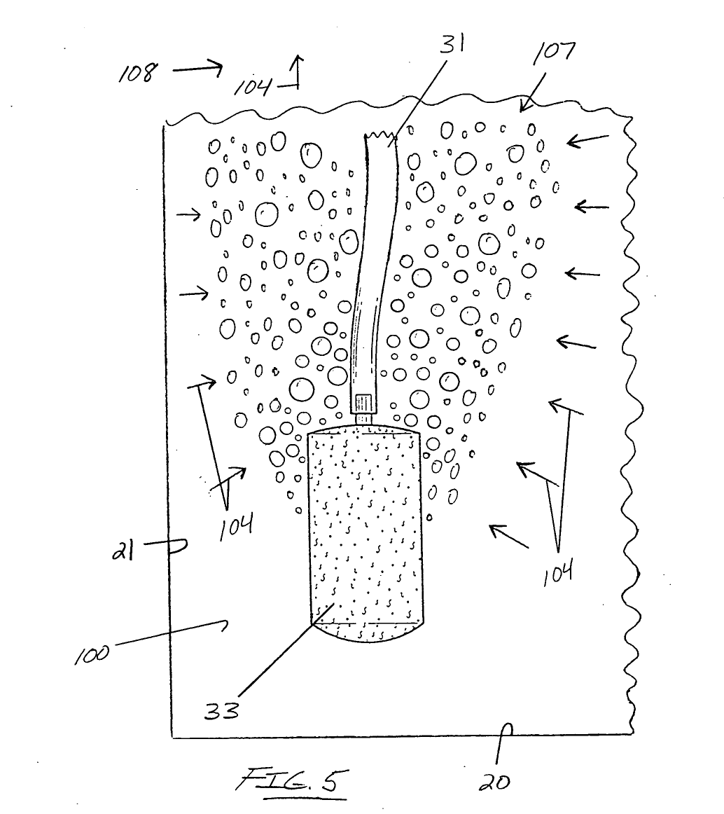

The means for aerating the water quantity 100 are preferably submerged in the water quantity 100 as generally depicted in FIGS. 1-3, 5, and 6 and the ice-bathed air flow 105(a) exits the aeration means thereby forming an aerated air flow 107 as illustrated and referenced in FIGS. 1-3, 5, and 6. The fourth heat content of the ice-bathed air flow 105(a) enables heat transfer from the water quantity 100 to the aerated air flow 107 (with increased or maximized surface area) for forming certain aerated exhaust, which aerated exhaust functions to release heat energy 104 to receptacle air 108 in superior adjacency to the water quantity 100 for controlling the air-heat condition of the water quantity 100 as comparatively depicted in FIGS. 2 and 5. The conditioned water quantity 100 thus functions to help sustaining live bait 101.

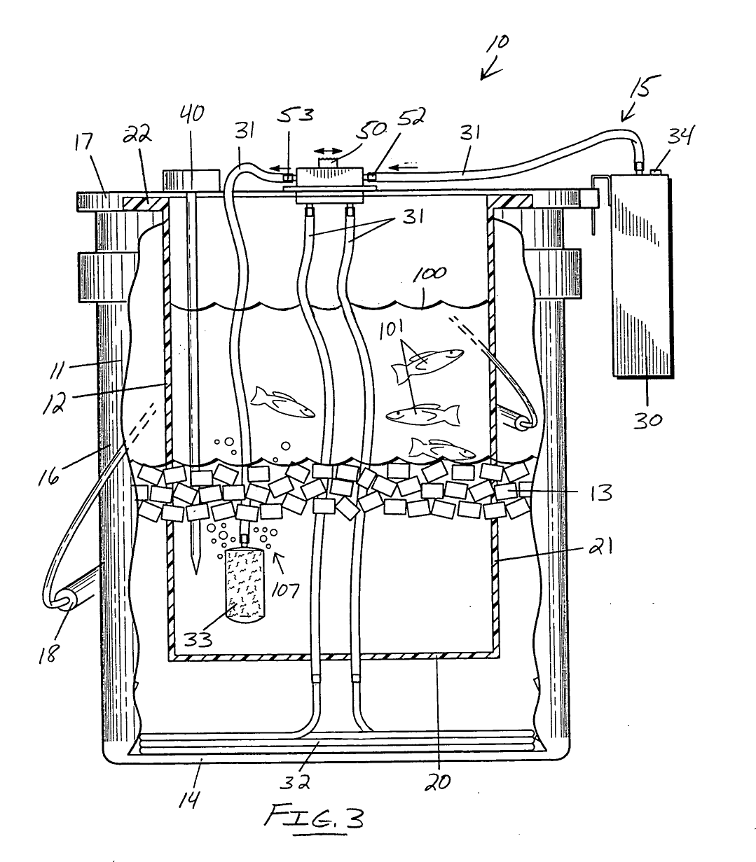

Preferably, the ice bath 13 is sandwiched intermediate container bottom 14 and receptacle bottom 20 as generally depicted in FIGS. 1 and 2, FIG. 1 roughly depicting an ice bath 13 in contact with receptacle bottom 20 and FIG. 2 roughly depicting an ice bath 13 disposed in non-contacting relation in inferior adjacency to receptacle bottom 20. FIG. 3 roughly depicts a third, alternative, scenario in which the ice bath 13 is disposed intermediate the container wall 16 and the receptacle wall 21 as well as intermediate the container bottom 14 and receptacle bottom 20.

Test results have shown that with (even modest) thermally insulative materials being used in the construction of outer container 11 and inner bait receptacle 12 that significant heat energy transfer is retarded as compared to the relatively more robust process of aerating the inner water quantity with a heat-conditioned air flow, as set forth in more detail below. Thus, the scenario generally depicted in FIG. 3 is an alternative structural configuration. In other words, immersing the inner bait receptacle 12 in an ice bath 13 as generally depicted in FIG. 3 is somewhat superfluous. The key heat transfer means being effected by the heat-conditioned and aerated airflows entering the water quantity. In this regard, it has been shown through testing that with outside ambient air temperature fluctuations on the order of 10 degrees Fahrenheit, the inner water quantity temperature fluctuated on the order of 1 degree Fahrenheit with the assembly running as set forth herein over a time period of roughly 12 hours.

The bait receptacle assembly 10 of the present invention may preferably further comprise certain water temperature-monitoring means for enabling the user to monitor the temperature of water quantity 100. It is contemplated that the temperature-monitoring means may be defined by any number of thermometers. A generic thermometer 40 is illustrated and referenced in FIGS. 1-3. As with most state of the art air pumps, the air pump 30 of the present invention comprises certain means for selectively operating the pump, such as an on-off switch 34 as generically illustrated and referenced in FIGS. 1-3. Together, the temperature-monitoring means or thermometer 40 and the on-off switch 34 of the air pump 30 enable the user to selectively control the air-heat condition of the water quantity 100.

Certain means for further exhausting bait receptacle 12 or receptacle exhaust means are further contemplated. In other words, is may be advantageous to periodically and selectively exhaust the receptacle air 108 to the ambient air 109 and for enabling the user to visually monitor the status of bait 101 received in the water quantity 100. In this regard, it is contemplated that the thermometer 40 may be removed and/or the receptacle top 22 may be removed to exhaust receptacle air 108 and to enable the user to visually monitor the status of bait 101.

It is further contemplated that the bait receptacle assembly 10 or the conduit assembly of the present invention may further preferably comprise certain air flow diversion means for enabling the user to selectively divert air flow 105 or to selectively bypass the bathable portion or conduit 32 for delivering air flow 105 having the third heat content (directly) to the aeration means. It will be recalled that the third heat content of air flow 105 is greater than the fourth heat content of the ice-bathed air flow 105(a), which fourth heat content is less than the second heat content of water quantity 100. The third heat content may thus be either greater than the second heat content or substantially equal thereto. Should the second and third heat content differ, the third heat content enables heat transfer from the aerated air flow 105 delivered directly to the aeration means and the water quantity 100 for further controlling the air-heat condition of water quantity 100.

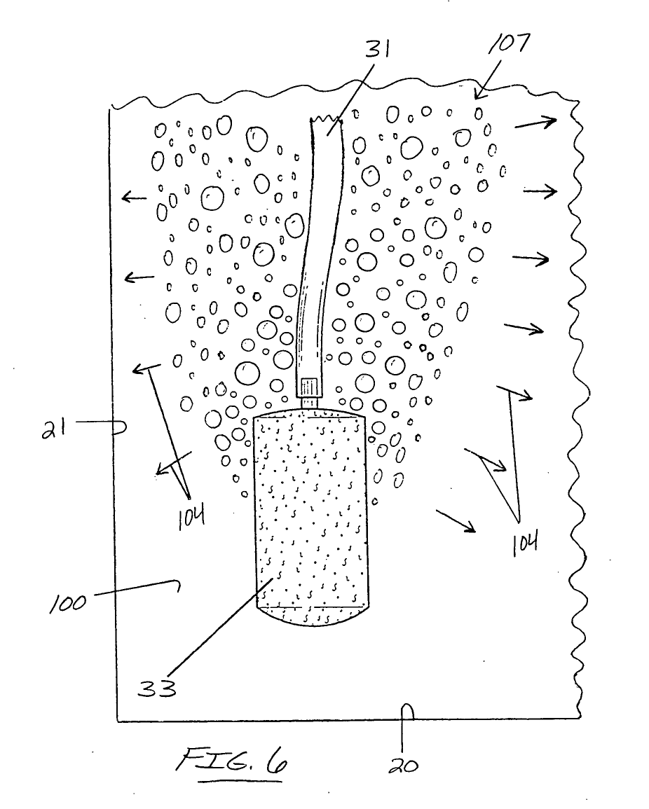

In other words, it may be helpful in certain circumstances, as for example, when the addition of relatively warmer water provides a bait-activating function, to warm the water from an otherwise overly chilled condition. The user may then operate the air flow diversion means and direct warmer air through the aeration means to either effect heat transfer or aerate the water without drawing further heat energy from the water quantity 100. The air flow diversion means may be defined by a series of valves or switches 50 for selectively directing air flow 105 through various heat-transferring environments, including the ice bath 13; or an ambient air environment 109 as referenced at vector arrow 109 in FIGS. 2 and 4; or even a heated or heat-suffusing environment 110 as diagrammatically depicted in FIG. 4. Certain gates 51 of valves or switches 50 have been generically depicted in FIG. 4 for enabling the user to direct air flow 105 through various heat-transferring environments, including a chilled environment as at 106, a heated environment as at 110, or an ambient environment as at 109. FIG. 4 further depicts an air flow inlet 52 and an air flow outlet 53 comparatively also shown in FIG. 3. Further a net transfer of heat energy 104 out of the aeration flow or otherwise diffused gaseous medium is depicted in FIG. 6 as compared to a net transfer of heat energy 104 into the aeration flow or otherwise diffused gaseous medium as generally depicted in FIG. 5.

In keeping with the foregoing notions, it is contemplated that the bait receptacle assembly 10 of the present invention may further comprise certain heat-suffusing means as may be preferably defined by an enclosed heater or heating element as diagrammatically depicted as a bound resistance circuit 60 in FIG. 4, through which a portion of the conduit assembly 35 may pass for receiving a relatively high third heat content of the air flow as depicted at reference numeral 105(b). This feature may be beneficial, for example, to keep bait active in extremely cold ambient temperatures. Thus, it is contemplated that certain heat-suffusing means may function to impart relatively high heat content (as compared to the second heat content of the water quantity) to the air flow 105. Together, the air flow diversion means and the heat-suffusing means are cooperable for enabling the user to direct air flow having a relatively high or higher third heat content to the aeration means.

Alternatively, it is contemplated that the heat-suffusing means may be defined by a heat pack/cold pack, which may be defined either by chemically-driven endothermic/exothermic reactions for providing the target heat-suffusing environment, or alternatively packs that may be pre-heated or pre-chilled, such as microwaveable heat packs or freezer packs and the like. These types of packs may be selectively placed into an environment, air flow may be selectively driven therethrough, and the heat-suffused air flow may be directed into the water quantity as previously stated.

While the above description contains much specificity, this specificity should not be construed as limitations on the scope of the invention, but rather as an exemplification of the invention. For example, the invention may be said to disclose a bait receptacle assembly 10 for controlling the condition of a bait-sustaining water quantity 100. The bait receptacle assembly essentially comprising a bait receptacle such as inner bait receptacle 12 having a receptacle bottom 20 and a receptacle wall 21; a select heat-transferring environment having a first heat content; a water quantity 100 contained by the receptacle wall 21 in superior adjacency to the receptacle bottom 20 and comprising a second heat content; and an aeration assembly such as the air delivery assembly 15 having a certain aeration assembly and a thermally conductive conduit portion such as conduit 32.

The aeration means are cooperatively associated with the water quantity 100 for enabling aeration thereof and the (thermally conductive) conduit portion extends through the heat-transferring environment. The heat-transferring environment functions to condition air flow flowing through the conduit portion by exchanging heat energy therewith. The conditioned air flow thereby develops a third heat content unequal to the second heat content. The conditioned air flow exits the aeration means thereby forming an aerated air flow. The third heat content being unequal to the second heat content enables heat transfer intermediate the water quantity and the aerated air flow for air-heat conditioning the water quantity. The conditioned water quantity function to help sustaining bait received therein.

An outer container having means for manually transporting the bait receptacle assembly may well function to retain said bait receptacle, the heat-transferring environment, and the aeration means and thus further function to contain the bait receptacle assembly as a single unit. The aeration assembly may further comprise certain air-flow diversion means for enabling the user to selectively bypass the heat-transferring environment for delivering unconditioned air flow directly to the water quantity, the unconditioned air flow having a fourth heat content typically unequal to the second heat content, the fourth heat content enabling heat transfer intermediate the unconditioned air flow and the water quantity for further controlling the air-heat condition of the water quantity.

Further, the foregoing teaches may be properly said to disclose certain methodology as reflected by or inherently taught by the underlying supporting structure(s) of the present invention. In this regard, it is contemplated that the present invention further discloses a method for controlling a bait-sustaining water temperature, the method comprising the step(s) of monitoring the temperature of a bait-sustaining water quantity, the temperature being subject to an acceptable range or a preferred temperature, the acceptable range being bound by and therefore falling within extreme parameters such as a lower extreme of 4° Celsius and a higher extreme of 35° Celsius, the preferred temperature being about 21.1° Celsius. The method may further comprise the step of treating the water quantity should the temperature exceed the acceptable range. The process of treating the water quantity or liquid medium according to the present invention may be said to comprise the steps of directing or pumping air or a gaseous medium through a select heat-transferring environment, the heat-transferring environment thereby transferring a first heat content into the air or gaseous medium and forming certain heat-conditioned airflow. Then, the user may aerate the water quantity with the heat-conditioned air. Notably, the water quantity has an initial second heat content, the first and second heat content(s) being unequal thereby enabling heat transfer intermediate the heat-suffused air and the water quantity according to classical thermodynamic principles for returning the water or liquid temperature to within the acceptable range.

The user may select a heat-transferring environment before directing air therethrough, which select heat-transferring environment may be selected from the group consisting of an ice bath, a heater, and an ambient air quantity. The step of aerating the water quantity may be terminated after the temperature of the water quantity returns to within the acceptable range.

Stated another way, the method for temperature-treating a liquid quantity such as water, as taught by the foregoing specifications may be said to properly comprise the steps of directing a gaseous medium through an heat-transferring environment and diffusing the gaseous medium through a liquid quantity. Notably, the heat-transferring environment transfers a first heat content into the gaseous medium, which first heat content is unequal to the heat content of the liquid quantity or medium. The diffusing gaseous medium thereby effects heat transfer intermediate the gaseous and liquid media for temperature-treating the liquid quantity.

Accordingly, although the invention has been described by reference to a preferred embodiment and certain methodology, it is not intended that the novel device or assembly be limited thereby, but that modifications thereof are intended to be included as falling within the broad scope and spirit of the foregoing disclosure, the following claims and the appended drawings.

We claim:

1. A bait receptacle assembly, the bait receptacle assembly for controlling the condition of a bait-sustaining water quantity, the bait receptacle assembly comprising, in combination:
an outer container, the outer container comprising a container bottom, and a container wall;
an inner bait receptacle, the bait receptacle being received by the outer container and comprising a receptacle bottom, and a receptacle wall;
an outer ice bath, the ice bath being contained by the container wall in superior adjacency to the container bottom and comprising a first heat content;
an inner water quantity, the water quantity being contained by the receptacle wall in superior adjacency to the receptacle bottom and comprising a second heat content, the first heat content being less than the second heat content; and
an air delivery assembly, the air delivery assembly comprising an air pump, a conduit assembly, and aeration means, the conduit assembly comprising an ice-bathable portion and communicating the air pump with the aeration means for enabling air flow therebetween, the air flow having an initial third heat content, the ice-bathable portion being submerged in the ice bath, the ice bath absorbing heat energy from the air flow, the ice-bathed air flow thereby comprising a fourth heat content greater than or substantially equal to the first heat content and less than the second heat content, the aeration means being submerged in the water quantity, the ice-bathed air flow exiting the aeration means thereby forming an aerated air flow, the fourth heat content enabling heat transfer from the water quantity to the aerated air flow for forming aerated exhaust, the aerated exhaust for releasing heat to receptacle air in superior adjacency to the water quantity for controlling the air-heat condition of the water quantity, the conditioned water quantity for sustaining live bait.

2. The bait receptacle assembly of claim 1 comprising temperature-monitoring means, the temperature-monitoring means for enabling the user to monitor the temperature of the water quantity, the air pump having an on-off switch, the temperature-monitoring means and the on-off switch enabling the user to selectively control the condition of the water quantity.

3. The bait receptacle assembly of claim 1 comprising receptacle exhaust means, the receptacle exhaust means for selectively exhausting the receptacle air to ambient air and for enabling the user to visually monitor the status of live bait received in the water quantity.

4. The bait receptacle assembly of claim 1 wherein the outer container comprises means for manually transporting the bait receptacle assembly.

5. The bait receptacle assembly of claim 1 wherein the conduit assembly comprises air flow diversion means, the air flow diversion means for enabling the user to selectively bypass the ice-bathable portion for delivering air flow having the third heat content to the aeration means, the third heat content being greater than the fourth heat content, the third heat content enabling heat transfer from the aerated air flow to the water quantity for further controlling the air-heat condition of the water quantity.

6. The bait receptacle assembly of claim 5 comprising heat-suffusing means, the heat-suffusing means for imparting a relatively high heat content to the air flow, the air flow diversion means and the heat-suffusing means being cooperable for enabling the user to direct air flow having a relatively high third heat content to the aeration means.

7. A bait receptacle assembly, the bait receptacle assembly for controlling the condition of a bait-sustaining water quantity, the bait receptacle assembly comprising:
a bait receptacle, the bait receptacle comprising a receptacle bottom and a receptacle wall;
a select heat-transferring environment, the heat-transferring environment comprising a first heat content;
a water quantity, the water quantity being contained by the receptacle wall in superior adjacency to the receptacle bottom and comprising a second heat content, the first heat content being unequal to the second heat content; and
an aeration assembly, the aeration assembly comprising aeration means and a thermally conductive conduit portion, the aeration means being cooperatively associated with the water quantity for enabling aeration thereof, the conduit portion extending through the heat-transferring environment, the heat-transferring environment conditioning the air flow by exchanging heat energy therewith, the conditioned air flow thereby developing a third heat content unequal to the second heat content, the conditioned air flow exiting the aeration means thereby forming an aerated air flow, the third heat content enabling heat transfer intermediate the water quantity and the aerated air flow for air-heat conditioning the water quantity, the conditioned water quantity for sustaining live bait.

8. The bait receptacle assembly of claim 7 comprising temperature-monitoring means, the temperature-monitoring means for enabling the user to monitor the temperature of the water quantity, the temperature-monitoring means and the aeration means enabling the user to selectively control the air-heat condition of the water condition.

9. The bait receptacle assembly of claim 7 comprising an outer container, the outer container retaining the bait receptacle, the heat-transferring environment, and the aeration means, the outer container thus for containing the bait receptacle assembly as a single unit.

10. The bait receptacle assembly of claim 7 comprising means for manually transporting the bait receptacle assembly.

11. The bait receptacle assembly of claim 7 wherein the aeration assembly comprises air-flow diversion means, the air flow diversion means for enabling the user to selectively bypass the heat-transferring environment for delivering selectively conditioned air flow to the water quantity, the selectively conditioned air flow having a fourth heat content unequal to the second heat content, the fourth heat content enabling heat transfer intermediate the selectively conditioned air flow and the water quantity for further controlling the air-heat condition of the water quantity.

12. The bait receptacle assembly of claim 11 wherein the heat-transferring environment is selected from the group consisting of an ice bath, a heater, and an ambient air quantity.

13. A method for controlling a bait-sustaining water temperature, the method comprising the steps of:
monitoring the temperature of a bait-sustaining water quantity, the temperature being subject to an acceptable temperature range;
treating the water quantity should the temperature exceed the acceptable range, the step of water quantity treatment comprising the steps of:
directing air through a select heat-transferring environment, the heat-transferring environment transferring a first heat content into the air thereby forming a heat-conditioned air flow; and
aerating the water quantity with the heat-conditioned airflow, the water quantity having a second heat content, the first and second heat content being unequal, the unequal first and second heat content enabling heat transfer intermediate the heat-conditioned airflow and the water quantity for returning the temperature to the acceptable range.

14. The method of claim 13 wherein the select heat-transferring environment is selected before directing air therethrough, the select heat-transferring environment being selected from the group consisting of an ice bath, a heater, and an ambient air quantity.

15. The method of claim 13 wherein aeration is terminated after the temperature of the water quantity returns to the acceptable range.

16. A method for heat-conditioning a liquid medium, the method comprising the steps of:
directing a gaseous medium through a heat-transferring environment, the heat-transferring environment transferring a first heat content into the gaseous medium;
diffusing the gaseous medium through a liquid medium, the liquid medium having a second heat content, the first heat content being unequal to the second heat content, the diffusing gaseous medium enabling heat transfer intermediate the gaseous and liquid media for heat-conditioning the liquid medium.

17. The method of claim 16 wherein the gaseous medium is air, the step of diffusing the gaseous medium through the liquid medium quantity being defined by aerating the liquid medium.

18. The method of claim 16 wherein the temperature of the liquid medium is monitored during heat-conditioning, the temperature being subject to an acceptable range, the heat-conditioning being selectively terminated when the temperature is within the acceptable range.

19. The method of claim 17 wherein the liquid medium is water, the temperature being subject to an acceptable, life-sustaining range.

20. The method of claim 16 wherein the select heat-transferring environment is selected from the group consisting of an ice bath, a heater, and an ambient air quantity.
